(19) United States
(12) Patent Application Publication
(10) Pub. No.: US 2011/0111901 A1
(43) Pub. Date: May 12, 2011

(54) Detachable Belt for a Belt Pulley Bicycle

(76) Inventor: Douglas CHIANG, Taichung County (TW)

(21) Appl. No.: 12/617,589

(22) Filed: Nov. 12, 2009

(51) Int. Cl. F16G 1/28

(52) U.S. Cl. 474/205

(57) ABSTRACT

A detachable belt for a belt pulley bicycle essentially comprises a toothed belt and a positioning unit. The toothed belt includes a first unit and a second unit at both ends thereof. The positioning unit is detachably assembled to the first and the second units to connect or disconnect the first and the second units, thus making it more convenient to replace the belt.

### BACKGROUND OF THE INVENTION

1. Field of the Invention

The present invention relates to a belt for a belt pulley bicycle; and more particularly to a detachable belt for a belt pulley bicycle.

2. Description of the Prior Art

Referring to FIG. 1, a conventional belt pulley bicycle has a belt 11 wound around a rear belt pulley 13 located at a rear end of a rear fork 13 and a front belt pulley 15 located at a multi-way pile 14 to drivingly connect the rear and the front belt pulleys 13, 15. Although this conventional belt pulley bicycle has the advantages of low noise and non-necessity of lubrication as compared to the chain bicycle, the belt 11 of this conventional belt pulley bicycle still suffers from the following drawbacks required to be immediately improved:

The rear belt pulley 13 is assembled between the rear wheel 16 and the rear fork 12 while the belt 11 is meshed between the rear belt pulley 13 and the front belt pulley 15, so that the belt 11 is also located between the rear wheel 16 and the rear fork 12. Therefore, once the belt 11 damages and needs replacing, the rear wheel 16 and the rear fork 12 must be detached by using tools first, and then a new belt 11 will be assembled on the rear belt pulley 13, and finally the rear wheel 16 and the rear fork 12 which have been detached must be reassembled after finishing the assembly of the new belt 11. Hence, it is inconvenient to replace the belt 11 of the conventional belt pulley bicycle.

The present invention has arisen to mitigate and/or obviate the afore-described disadvantages.

### SUMMARY OF THE INVENTION

The primary objective of the present invention is to provide a detachable belt for a belt pulley bicycle which can make it more convenient to replace the belt.

In order to achieve the above objective, a detachable belt for a belt pulley bicycle in accordance with the present invention comprises a toothed belt and a positioning unit. The toothed belt includes a first unit and a second unit at both ends thereof, when the first unit is connected to the second unit, the toothed belt will form an annular structure. The positioning unit is detachably assembled to the first and the second units to connect or disconnect the first and the second units.

In addition, the positioning unit includes a threaded sleeve with an inner threaded hole and a threaded rod with an outer threaded portion. The threaded sleeve is inserted into the first and the second units from one side of the toothed belt, the threaded rod is inserted into the first and the second units from the other side of the toothed belt, and the outer threaded portion of the threaded rod is screwed into the inner threaded hole of the threaded sleeve.

### BRIEF DESCRIPTION OF THE DRAWINGS

FIG. 1 is a plane view of a conventional belt pulley bicycle, showing that how the belt is assembled on the belt pulley bicycle;

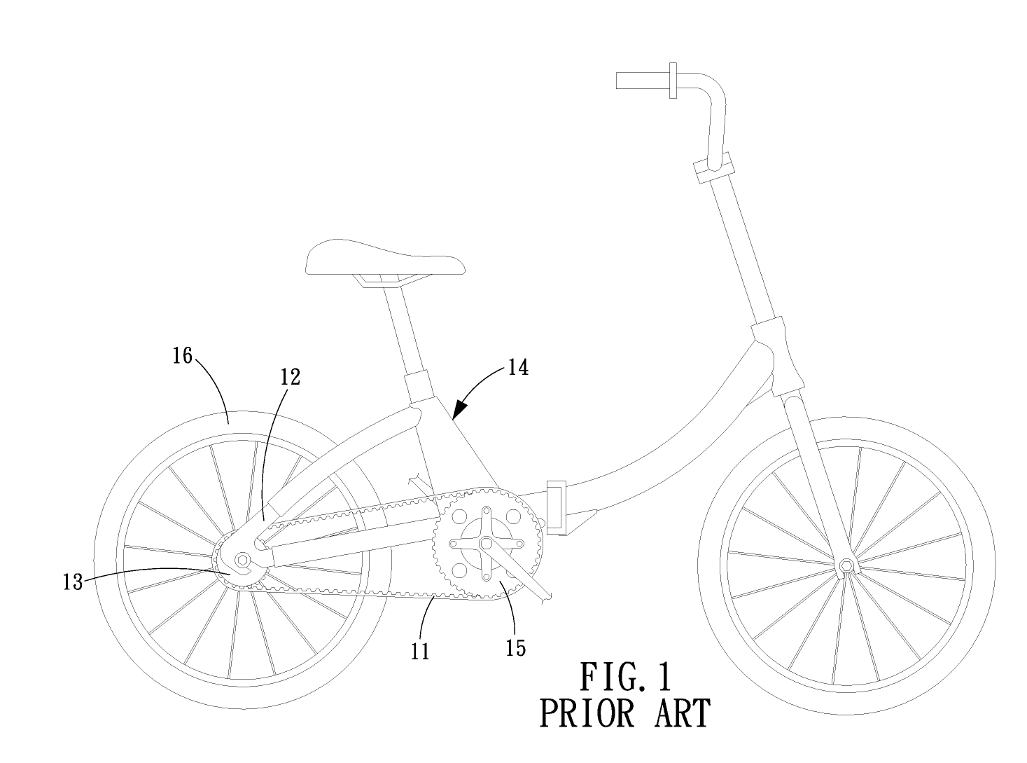

FIG. 2 is a perspective view of a detachable belt for a belt pulley bicycle in accordance with a first embodiment of the present invention;

FIG. 3 is a partial enlarged view of FIG. 2;

FIG. 4 is a partial exploded view of the detachable belt for a belt pulley bicycle in accordance with the first embodiment of the present invention;

FIG. 5 is a partial cross-sectional view of the detachable belt for a belt pulley bicycle in accordance with the first embodiment of the present invention;

FIG. 6 is another partial cross-sectional view of the detachable belt for a belt pulley bicycle in accordance with the first embodiment of the present invention, showing that the present invention is further provided with gaskets;

FIG. 7 is a partial cross-sectional view of a detachable belt for a belt pulley bicycle in accordance with a second embodiment of the present invention;

FIG. 8 is another partial cross-sectional view of the detachable belt for a belt pulley bicycle in accordance with the second embodiment of the present invention, showing that the present invention is further provided with gaskets;

FIG. 9 is another partial cross-sectional view of the detachable belt for a belt pulley bicycle in accordance with the first embodiment of the present invention, showing that the head portion of the threaded sleeve and the head portion of the threaded rod are oppositely located in the through holes of the first protrusions; and

FIG. 10 is another partial cross-sectional view of the detachable belt for a belt pulley bicycle in accordance with the second embodiment of the present invention, showing that the head portion of the threaded sleeve and the head portion of the threaded rod are oppositely located in the through holes of the third protrusion and the fourth protrusion.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

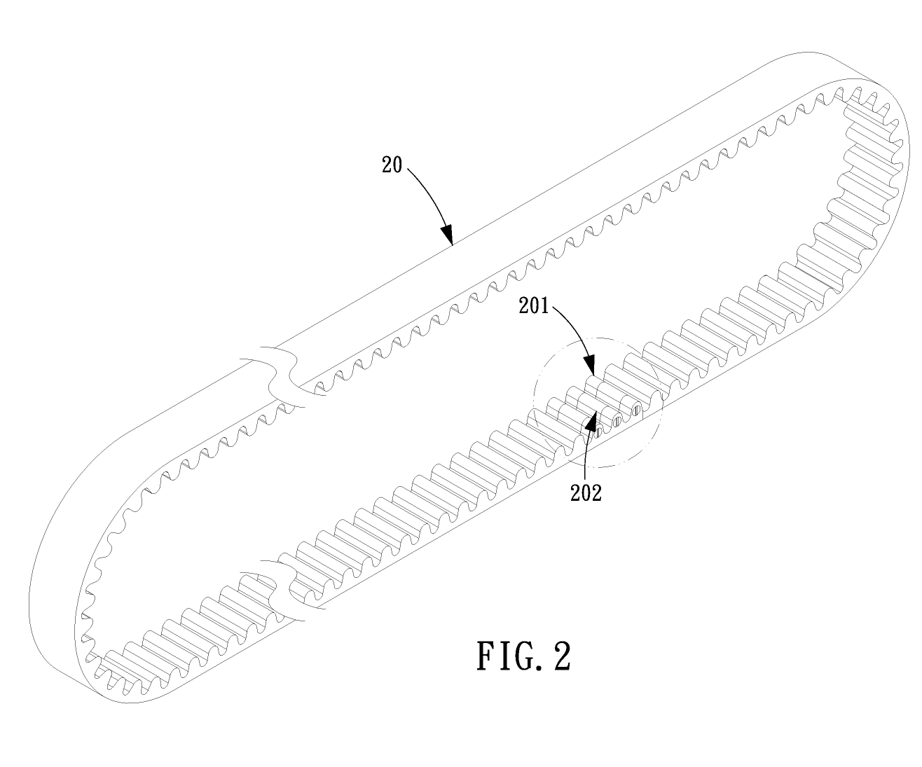

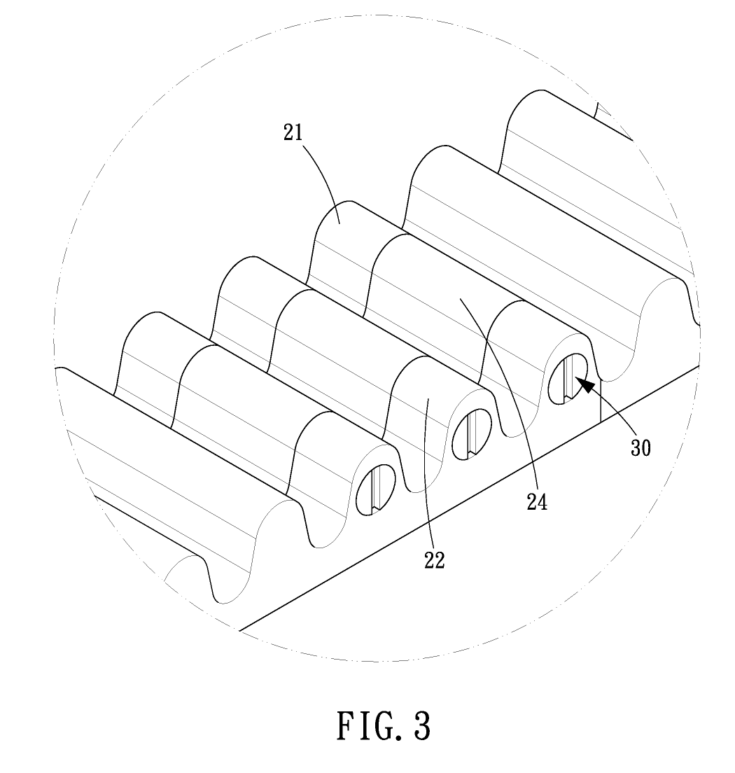

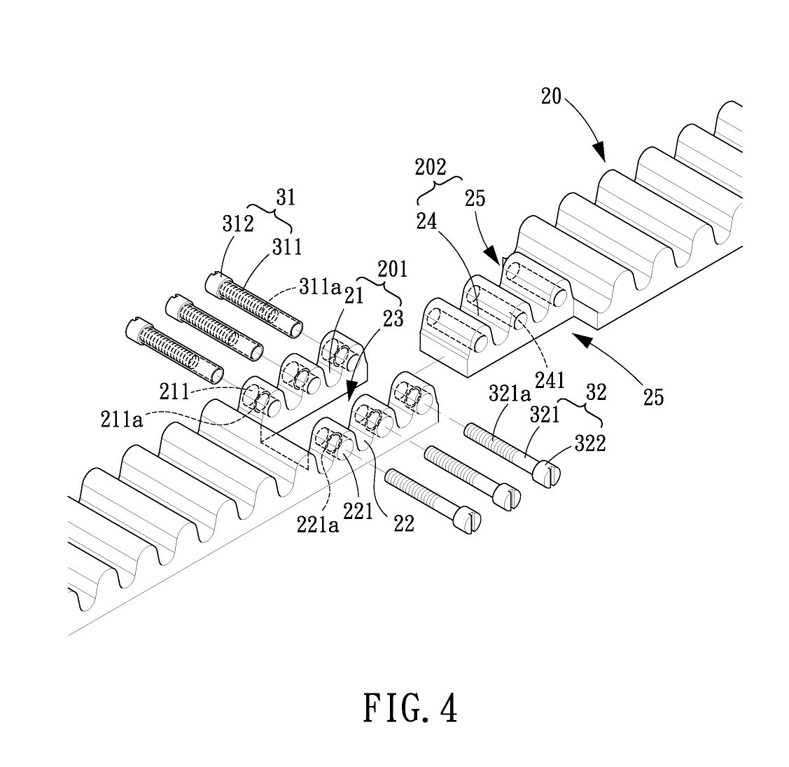

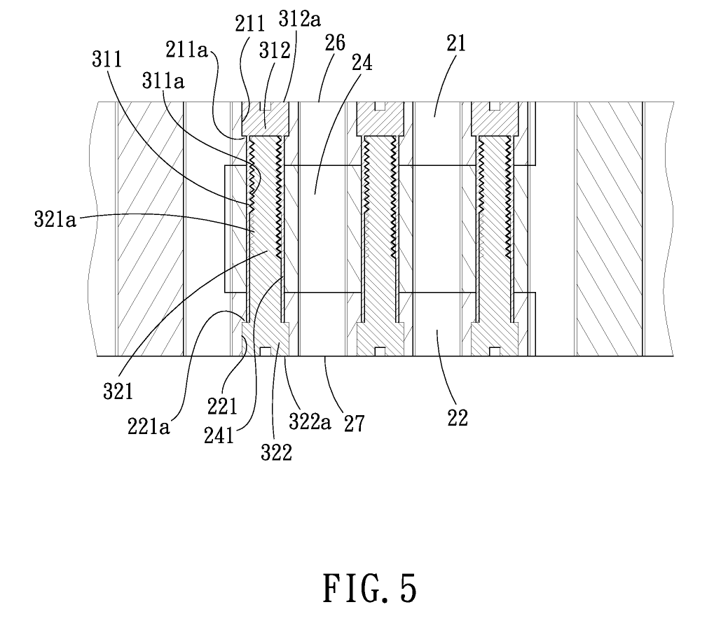

Referring to FIGS. 2-5, a detachable belt for a belt pulley bicycle in accordance with a first embodiment of the present invention essentially comprises a toothed belt 20 and a positioning unit 30.

The toothed belt 20 is a belt body provided with plural teeth on a surface thereof. The toothed belt 20 includes a first unit 201 and a second unit 202 at both ends thereof in such a manner that when the first unit 201 is connected to the second unit 202, the toothed belt 20 will form an annular structure. The first unit 201 includes two first protrusions 21, 22 disposed at one end of the toothed belt 20, and a notch 23 defined between the two first protrusions 21, 22. Each of the first protrusions 21, 22 includes three through holes 211, 221. Each of the through holes 211, 221 includes a shoulder 211a, 221a. The second unit 202 includes a second protrusion 24 at the other end of the toothed belt 20, and two second notches 25 at both sides of the second protrusion 24. The second protrusion 21 includes three through holes 241 to be aligned with the three through holes of each of the first protrusions 21, 22, respectively. The first protrusions 21, 22 are correspondingly disposed in the respective second notches 25, and the second protrusion 24 is correspondingly disposed in the first notch 23, so that the through holes 211, 221 are in communication with the respective through holes 241.

The positioning unit 30 is detachably assembled to the first unit 201 and the second unit 202 to connect or disconnect the first unit 201 and the second unit 202. The positioning unit 30 includes a threaded sleeve 31 and a threaded rod 32. The threaded sleeve 31 includes a body portion 311 and a head portion 312 having an outer diameter greater than an outer diameter of the body portion 311. The body portion 311 is formed with an inner threaded hole 311a. The threaded sleeve 31 is inserted into the first and the second units 201, 202 from one side of the toothed belt 20 in such a manner that the body portion 311 of the threaded sleeve 31 is inserted into the through holes 211, 221, 241, the head portion 321 abuts against the shoulder 211a of the through hole 211, and an end surface 312a of the head portion 312 is located flush with one side surface 26 of the toothed belt 20. The threaded rod 32 includes a body portion 321 and a head portion 322 having an outer diameter greater than an outer diameter of the body portion 321. The body portion 321 is formed with an outer threaded portion 321a. The threaded rod 32 is inserted into the first and the second units 201, 202 from the other side of the toothed belt 20 in such a manner that the outer threaded portion 321a is screwed into the inner threaded hole 311a of the threaded sleeve 31, the head portion 322 abuts against the shoulder 221a of the through hole 221, and the end surface 322a of the head portion 322 is located flush with the other side surface 27 of the toothed belt 20.

The aforementioned is the summary of the positional and structural relationship of the respective components of the first embodiment in accordance with the present invention.

When the belt in accordance with the first embodiment damages and needs replacing, the damaged toothed belt 20 will be pulled or cut apart and then detached from the bicycle first, and then the first unit 201 or the second unit 202 of a new unconnected toothed belt 20 will serve as a head end of the toothed belt 20 to be inserted, at this moment, the toothed belt 20 can be smoothly inserted through a combined portion of the belt pulley bicycle, and after the toothed belt 20 is positioned, the positioning unit 30 will be inserted through the first and the second units 201, 202 of the toothed belt 20 to finish the belt assembly. Hence, the present invention can assuredly make it more convenient to replace the belt, avoiding the operations of disassembling and assembling the rear wheel, rear fork or other portions using the tools.

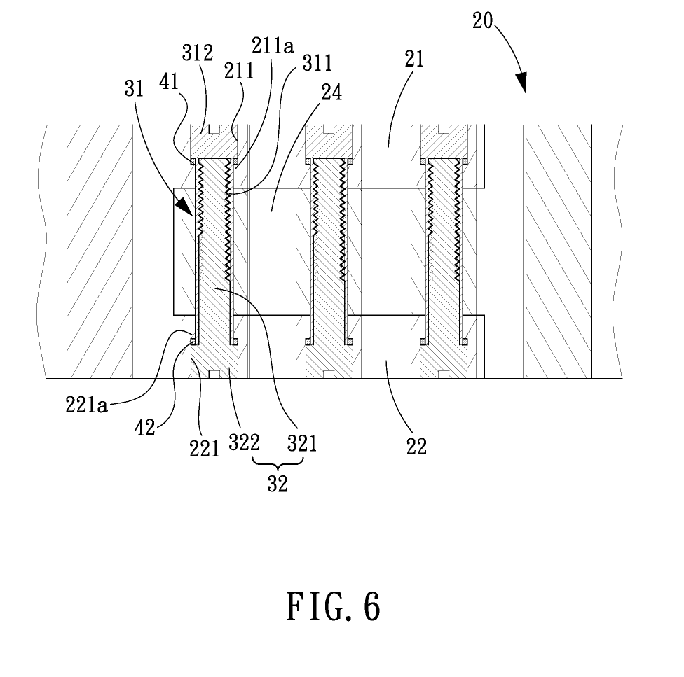

Referring to FIG. 6, in the first embodiment, on each of the shoulders 211a, 221a of the through holes 211, 221 of the first protrusions 21, 22 of the toothed belt is provided a gasket 41, 42, the body portion 311 of the threaded sleeve 31 is inserted through the gasket 41 while the head portion 312 of the threaded sleeve 31 presses against the gasket 41, that is to say, the gasket 41 is located between the head portion 312 and the shoulder 211a. The body portion 321 of the threaded rod 32 is inserted through the gasket 42 while the head portion 322 of the threaded rod 32 presses against the gasket 42, that is to say, the gasket 42 is located between the head portion 322 and the shoulder 221a. By such arrangements, the head portion 312 of the threaded sleeve 31 and the head portion 322 of the threaded rod 32 can be prevented from directly pressing against the shoulders 211a, 221a, thus avoiding damage to the shoulders 211a, 221a.

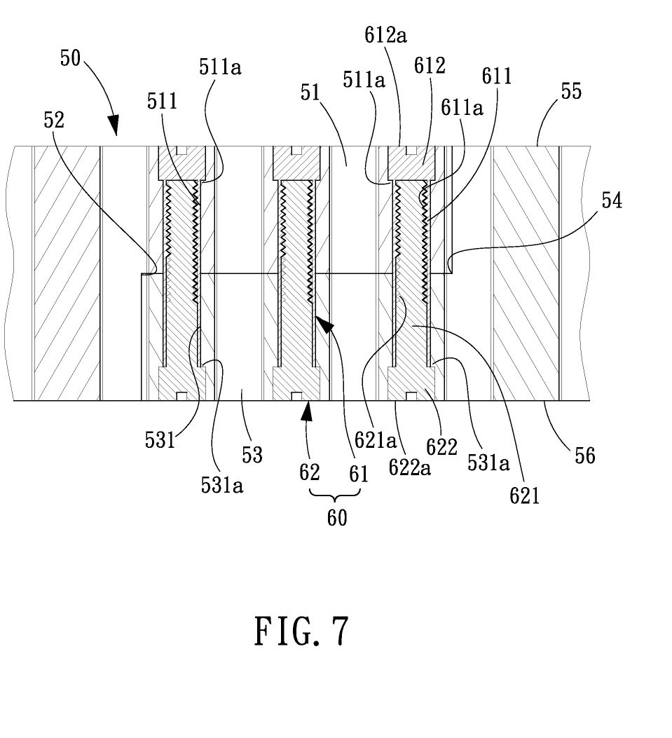

Referring to FIG. 7, a detachable belt for a belt pulley bicycle in accordance with a second embodiment of the present invention also essentially comprises a toothed belt 50 and a positioning unit 60. The configurations and functions of the second embodiment are the same as the first embodiment, so further explanations will be omitted. The difference between the first embodiment and the second embodiment is described as follows:

The toothed belt 50 is a belt body provided with plural teeth on a surface thereof. The toothed belt 50 includes a first unit and a second unit at both ends thereof in such a manner that when the first unit is connected to the second unit, the toothed belt 50 will form an annular structure. The first unit includes a third protrusion 51 at one end of the toothed belt 50, and a third notch 52 at one side of the third protrusion 51. The third protrusion 51 includes three though holes 511, and each of the through holes 511 includes a shoulder 511a. The second unit includes a fourth protrusion 53 at the other end of the toothed belt 50, and a fourth notch 54 located at one side of the fourth protrusion 53. The fourth protrusion 53 includes three through holes 531 to be aligned with the respective three through holes 511. Each of the through holes 531 includes a shoulder 531a. The third protrusion 51 is correspondingly disposed in the fourth notch 54, and the fourth protrusion 53 is correspondingly disposed in the third notch 52, so that the through holes 511 are in communication with the corresponding through holes 531.

The positioning unit 60 is detachably assembled to the first unit and the second unit to connect or disconnect the first unit and the second unit. The positioning unit 60 includes a threaded sleeve 61 and a threaded rod 62. The threaded sleeve 61 includes a body portion 611 and a head portion 612 having an outer diameter greater than an outer diameter of the body portion 611. The body portion 611 is formed with an inner threaded hole 611a. The threaded sleeve 61 is inserted into the first and the second units (namely the third and the fourth protrusions 51, 53) from one side of the toothed belt 50 in such a manner that the body portion 611 of the threaded sleeve 61 is inserted into the through holes 511, 531, the head portion 612 abuts against the shoulder 511a of the through hole 511, and the end surface 612a of the head portion 612 is located flush with one side surface 55 of the toothed belt 50. The threaded rod 62 includes a body portion 621 and a head portion 622 having an outer diameter greater than an outer diameter of the body portion 621. The body portion 621 is formed with an outer threaded portion 621a. The threaded rod 62 is inserted into the first and the second units from the other side of the toothed belt 50 in such a manner that the outer threaded portion 621a is screwed into the inner threaded hole 611a of the threaded sleeve 61, the head portion 622 abuts against the shoulder 531a of the through hole 531, and the end surface 622a of the head portion 622 is located flush with the other side surface 56 of the toothed belt 50.

The aforementioned is the summary of the positional and structural relationship of the respective components of the second embodiment in accordance with the present invention.

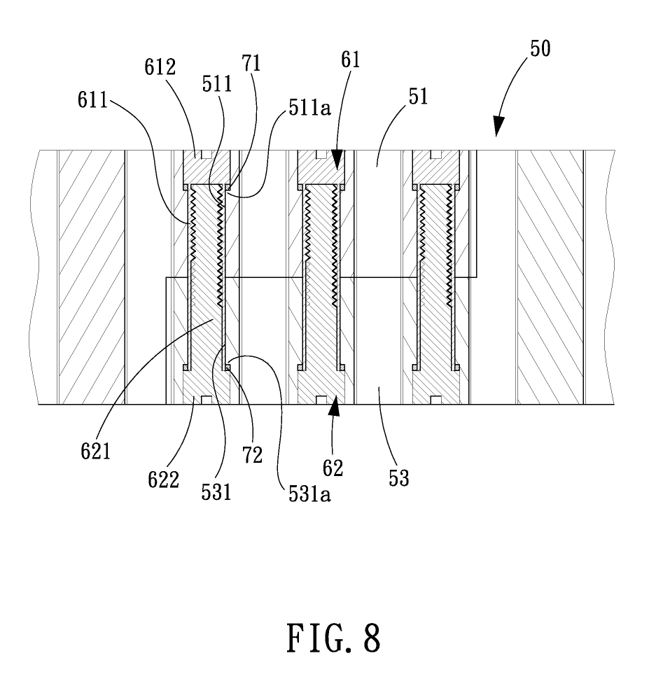

As shown in FIG. 8, on each of the shoulders 511a, 531a of the through holes 511, 531 of the third protrusion 51 and the fourth protrusion 53 of the toothed belt 50 is provided a gasket 71, 72. The body portion 611 of the threaded sleeve 61 is inserted through the gasket 71 while the head portion 612 presses against the gasket 71, that is to say, the gasket 71 is located between the head portion 612 and the shoulder 511a. The body portion 621 of the threaded rod 62 is inserted through the gasket 72 while the head portion 622 presses against the gasket 72, that is to say, the gasket 72 is located between the head portion 622 and the shoulder 531a. By such arrangements, the head portion 612 of the threaded sleeve 61 and the head portion 622 of the threaded rod 62 can be prevented from directly pressing against the shoulders 511a, 531a, thus avoiding damage to the shoulders 511a, 531a.

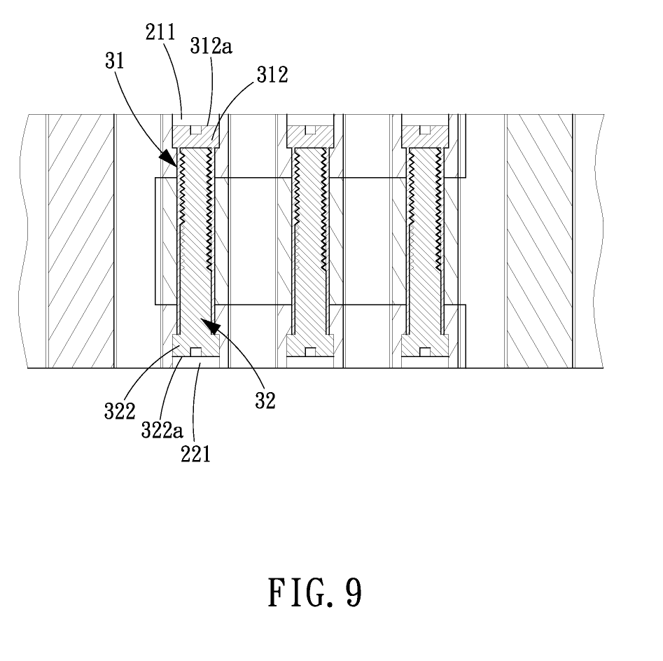

In addition, as shown in FIG. 9, in the first embodiment of the present invention, the head portion 312 of the threaded sleeve 31 and the head portion 322 of the threaded rod 32 can also be oppositely located in the through hole 211 and the through hole 221 of the first protrusions 21, 22 in such a manner that the end surface 312a of the head portion 312 sinks into the through hole 211, and the end surface 322a of the head portion 322 sinks into the through hole 221.

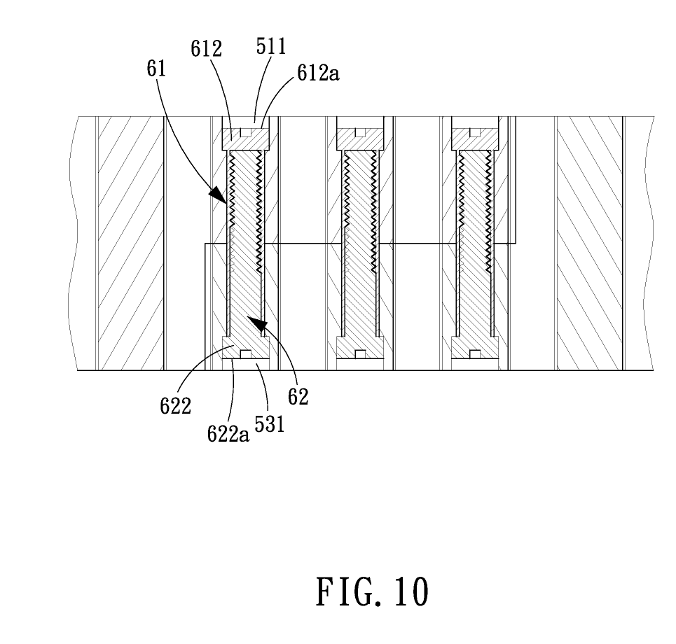

As shown in FIG. 10, in the second embodiment of the present invention, the head portion 612 of the threaded sleeve 61 and the head portion 622 of the threaded rod 62 can also be oppositely located in the through hole 511 and the through hole 531 of the third and the fourth protrusions 51, 53 in such a manner that the end surface 612a of the head portion 612 sinks into the through hole 511, and the end surface 622a of the head portion 622 sinks into the through hole 531.

While we have shown and described various embodiments in accordance with the present invention, it is clear to those skilled in the art that further embodiments may be made without departing from the scope of the present invention.

What is claimed is:

1. A detachable belt for a belt pulley bicycle comprising:
a toothed belt including a first unit and a second unit at both ends thereof, when the first unit being connected to the second unit, the toothed belt forming an annular structure; and
a positioning unit being detachably assembled to the first unit and the second unit to connect or disconnect the first and the second units.

2. The detachable belt for a belt pulley bicycle as claimed in claim 1, wherein the positioning unit includes a threaded sleeve with an inner threaded hole and a threaded rod with an outer threaded portion, the threaded sleeve is inserted into the first and the second units from one side of the toothed belt, and the threaded rod is inserted into the first and the second units from the other side of the toothed belt, and the outer threaded portion of the threaded rod is screwed into the inner threaded hole of the threaded sleeve.

3. The detachable belt for a belt pulley bicycle as claimed in claim 1, wherein the first unit includes two first protrusions at one end of the toothed belt and a first notch defined between the two first protrusions, the second unit includes a second protrusion at the other end of the toothed belt and two second notches located at both sides of the second protrusion, the first protrusions are correspondingly disposed in the second notches, and the second protrusion is correspondingly disposed in the first notch.

4. The detachable belt for a belt pulley bicycle as claimed in claim 3, wherein the positioning unit includes a threaded sleeve with an inner threaded hole and a threaded rod with an outer threaded portion, the threaded sleeve is inserted into the two first protrusions and the second protrusion from one side of the toothed belt, and the threaded rod is inserted into the two first protrusions and the second protrusion from the other side of the toothed belt, and the outer threaded portion of the threaded rod is screwed into the inner threaded hole of the threaded sleeve.

5. The detachable belt for a belt pulley bicycle as claimed in claim 4, wherein each of the first protrusions includes a through hole having a shoulder, the second protrusion includes a through hole to be aligned to the through hole of each of the first protrusions, the threaded sleeve includes a body portion and a head portion having an outer diameter greater than an outer diameter of the body portion, the inner threaded hole is formed in the body portion of the threaded sleeve, the body portion of the threaded sleeve is inserted into the through holes of the two first protrusions and the through hole of the second protrusion, and the head portion of the threaded sleeve abuts against the shoulder of one of the through holes of the first protrusions, the threaded rod includes a body portion and a head portion having an outer diameter greater than an outer diameter of the body portion of the threaded rod, the outer threaded portion is formed on the body portion of the threaded rod, the body portion of the threaded rod is screwed into the body portion of the threaded sleeve, and the head portion of the threaded rod abuts against the shoulder of the other of the through holes of the first protrusions.

6. The detachable belt for a belt pulley bicycle as claimed in claim 5, wherein a gasket is disposed on the shoulder of each of the through holes of the first protrusions, the body portion of the threaded sleeve is inserted through one of the gaskets while the head portion of the threaded sleeve presses against the one of the gaskets, the body portion of the threaded rod is inserted through the other of the gaskets while the head portion of the threaded rod presses against the other of the gaskets.

7. The detachable belt for a belt pulley bicycle as claimed in claim 5, wherein an end surface of the head portion of the threaded sleeve is located flush with one side surface of the toothed belt, and an end surface of the head portion of the threaded rod is located flush with the other side surface of the toothed belt.

8. The detachable belt for a belt pulley bicycle as claimed in claim 5, wherein the head portion of the threaded sleeve is located in one of the through holes of the first protrusions, and the head portion of the threaded rod is located in the other of the through holes of the first protrusions.

9. The detachable belt for a belt pulley bicycle as claimed in claim 1, wherein the first unit includes a third protrusion at one end of the toothed belt and a third notch at one side of the third protrusion, the second unit includes a fourth protrusion at the other end of the toothed belt and a fourth notch at one side of the fourth protrusion, the third protrusion is correspondingly disposed in the fourth notch, and the fourth protrusion is correspondingly disposed in the third notch.

10. The detachable belt for a belt pulley bicycle as claimed in claim 9, wherein the positioning unit includes a threaded sleeve with an inner threaded hole and a threaded rod with an outer threaded portion, the threaded sleeve is inserted into the third protrusion and the fourth protrusion from one side of the toothed belt, and the threaded rod is inserted into the fourth protrusion and the third protrusion from the other side of the toothed belt, the outer threaded portion of the threaded rod is screwed into the inner threaded hole of the threaded sleeve.

11. The detachable belt for a belt pulley bicycle as claimed in claim 10, wherein the third protrusion includes a through hole having a shoulder, the fourth protrusion includes a through hole having a shoulder, the threaded sleeve includes a body portion and a head portion having an outer diameter greater than an outer diameter of the body portion of the threaded sleeve, the inner threaded hole is formed in the body portion of the threaded sleeve, the body portion of the threaded sleeve is inserted into the through holes of the third and the fourth protrusions, the head portion of the threaded sleeve abuts against the shoulder of the through hole of the third protrusion, the threaded rod includes a body portion and a head portion having an outer diameter greater than an outer diameter of the body portion of the threaded rod, the outer threaded portion is formed on the body portion of the threaded rod, the body portion of the threaded rod is screwed into the body portion of the threaded sleeve, and the head portion of the threaded rod abuts against the shoulder of the through hole of the fourth protrusion.

12. The detachable belt for a belt pulley bicycle as claimed in claim 11, wherein a gasket is disposed on the shoulder of each of the through holes of the third protrusion and the fourth protrusion, the body portion of the threaded sleeve is inserted through one of the gasket while the head portion of the threaded sleeve presses against the one of the gaskets, and the body portion of the threaded rod is inserted through the other of the gaskets while the head portion of the threaded rod presses against the other of the gaskets.

13. The detachable belt for a belt pulley bicycle as claimed in claim 12, wherein an end surface of the head portion of the threaded sleeve is located flush with one side surface of the toothed belt, and an end surface of the head portion of the threaded rod is located flush with the other side surface of the toothed belt.

14. The detachable belt for a belt pulley bicycle as claimed in claim 11, wherein the head portion of the threaded sleeve is located in the through hole of the third protrusion, and the head portion of the threaded rod is located in the through hole of the fourth protrusion.
